(19) United States
(12) Patent Application Publication
(10) Pub. No.: US 2009/0130473 A1
(43) Pub. Date: May 21, 2009

(54) CARRIER FILM FOR FORMING CERAMIC GREEN SHEET AND METHOD OF FABRICATING CERAMIC GREEN SHEET

(76) Inventors: Beom Joon CHO, Yoingin (KR); Jong Myeon LEE, Gwacheon (KR); Soo Hyun LYOO, Yongin (KR); Ho Sung CHOO, Suwon (KR)

Correspondence Address: MCDERMOTT WILL & EMERY LLP, 600 13TH STREET, N.W., WASHINGTON, DC, 20005-3096, US

(21) Appl. No.: 12/271,378

(22) Filed: Nov. 14, 2008

(30) Foreign Application Priority Data
Nov. 16, 2007 (KR) 10-2007-0117234

(51) Int. Cl. B32B 27/00; B05D 3/00

(52) U.S. Cl. 428/480; 428/532; 427/372.2

(57) ABSTRACT

Provided is a carrier film for forming a ceramic green sheet. The carrier film includes a film-type base material for fabricating the ceramic green sheet, a binder layer disposed on the film-type base material, the binder layer being formed of a binder resin, and a delamination layer disposed on a bottom surface of the carrier film, the delamination layer being formed of a resin having a releasing property. Also, provided is a method for fabricating a ceramic green sheet. The method includes preparing a carrier film for forming the ceramic green sheet including a binder layer, coating a ceramic slurry onto the carrier film, and drying the coated ceramic slurry to form the ceramic green sheet.

### CROSS-REFERENCE TO RELATED APPLICATIONS

This application claims the priority of Korean Patent Application No. 2007-117234 filed on Nov. 16, 2007 in the Korean Intellectual Property Office, the disclosure of which is incorporated herein by reference.

### BACKGROUND OF THE INVENTION

1. Field of the Invention

The present invention relates to a carrier film for forming a ceramic green sheet, and more particularly, to a carrier film that can fabricate a ceramic green sheet having a high packing density of ceramic powder, and a ceramic sheet product using the carrier film and a method of fabricating the same.

2. Description of the Related Art

In general, a ceramic green sheet for a multilayer ceramic component such as a low temperature co-fired ceramic (LTCC) substrate is fabricated using a ceramic slurry containing ceramic powder, a binder, and all kinds of additives (for example, dispersants, plasticizers, etc). The ceramic slurry passes through a gap having a predetermined thickness, and then, is dried on a carrier film for forming a ceramic green sheet to obtain the ceramic green sheet.

The carrier film used for forming the ceramic green sheet includes a base material such as a polyester film and a delamination layer formed by coating a resin having a releasing property onto a top surface of the base material. The carrier film is used only as a passive service that supports temporarily the ceramic green sheet and then is separated.

In recent, as a ceramic layer for the multilayer ceramic component becomes thinner, a demand with respect to surface properties of the carrier film increases. Particularly, a prime goal is to develop a carrier film having a low surface roughness and an improved releasing property. In a formation of a green sheet having several micron thicknesses, in case where the surface roughness of the carrier film is poor, accuracy or quality of a casting tape may be deteriorated. Also, in case where the releasing property is poor, the green sheet may be easily damaged when a thin film tape is separated from the carrier film. Thus, the carrier film having the low surface roughness and the improved releasing property is being developed.

However, the above-described studies are available only in case where a component mixture in which the ceramic slurry for fabricating the ceramic green sheet is stably formed on the carrier film is maintained. For example, in case where a binder component of the slurry decreases up to less than 3% in order to extremely increase a powder packing density of the green sheet, it is nearly impossible to form a useful ceramic green sheet on a related art carrier film.

There is devised a method in which the carrier film can perform an active role allowing the green tape to be endowed with a performance such as a physical strength to widely adjust a slurry composition and realize thinning and high integration of the green tape.

When the above-described slurry is fabricated, the binder is a macromolecule having a molecular weight ranging from about 30,000 to about 80,000 and supports respective links between molecules. Thus, the binder performs a role for maintaining a configuration of the green sheet and the physical strength. However, in case where a macromolecular binder having a relatively high viscosity is used, dispersibility of the slurry is lower. As a result, the binder is not uniformly dispersed when compared to other components such as the ceramic powder. Therefore, the binder is not uniformly distributed within the green sheet, and the ceramic powder is not stably rearranged in a drying process of the green sheet formation process due to the macromolecular having the relatively high viscosity.

Furthermore, when the green sheet is laminated, interlayer coupling by the binder is possible. At this time, when an amount of the binder is insufficient, the interlayer coupling is not performed properly. On the other hand, when the amount of the binder is too much, the number of pores may increase due to a de-binder after firing to decrease sinterability. Also, since positions occupied once by the binder within the ceramic powder remain as the pores, it is difficult to achieve densification during firing and accurately control a firing shrinkage rate of a laminated body even if moderate amounts of the binder are used.

### SUMMARY OF THE INVENTION

An aspect of the present invention provides a carrier film for forming a ceramic green sheet that can secure low binder contents and a high powder packing density of the ceramic green sheet.

Another aspect of the present invention provides a method of fabricating a ceramic green sheet having low binder contents and a high powder packing density using a carrier film.

According to an aspect of the present invention, there is provided a carrier film for forming a ceramic green sheet including: a film-type base material for fabricating the ceramic green sheet; a binder layer disposed on the film-type base material, the binder layer being formed of a binder resin; and a delamination layer disposed on a bottom surface of the carrier film, the delamination layer being formed of a resin having a releasing property.

The binder resin may be formed of at least one selected from the group consisting of vinyl-based resins, cellulose-based resins, and acrylic-based resins.

The carrier film for forming a ceramic green sheet may further include an additional delamination layer disposed between the binder layer and the film-type base material and formed of the resin having the releasing property.

According to another aspect of the present invention, there is provided a method of fabricating a ceramic green sheet including: preparing a carrier film for forming the ceramic green sheet including a film-type base material for fabricating the ceramic green sheet, a binder layer disposed on the film-type base material, the binder layer being formed of a binder resin, and a delamination layer disposed on a bottom surface of the carrier film, the delamination layer being formed of a resin having a releasing property; coating a ceramic slurry onto the carrier film; and drying the coated ceramic slurry to form the ceramic green sheet.

The method of fabricating a ceramic green sheet may further include separating the ceramic green sheet from the carrier film so that the binder layer is maintained on a bottom surface of the ceramic green sheet.

The ceramic slurry may be prepared by mixing a solvent with a mixture of at least ceramic powder and binder, and the mixture contains the ceramic powder ranging from about 90 wt % to about 99.5 wt % and the binder ranging from about 0.5 wt % to about 10 wt %, based on a total weight.

The ceramic green sheet may have a ceramic powder packing density of about 90% or more.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a carrier film for forming a ceramic green sheet according to an embodiment of the present invention;

FIG. 2 is a view illustrating a ceramic slurry coating process using a doctor blade process capable of being used in a ceramic green sheet fabrication process according to an example of the present invention;

FIGS. 3A and 3B are cross-sectional views for explaining a separation process of the ceramic green sheet obtained in FIG. 2;

FIG. 4 is a photograph showing a cross-section of a carrier film for forming a ceramic green sheet used in an embodiment according to the present invention;

FIG. 5 is a photograph showing a cross-section of a ceramic green sheet obtained through an embodiment according to the present invention;

FIG. 6 is a graph illustrating tensile test results of ceramic green sheets obtained from an embodiment according to the present invention and a comparative example according to a related art.

FIGS. 7A to 7C are cross-sectional photographs illustrating respective firing shrinkage rates at different lamination pressure conditions (1 MPa, 10 MPa, and 30 MPa) when a laminated body of a ceramic green sheet obtained from an embodiment according to the present invention is fired;

FIGS. 8A to 8C are cross-sectional photographs illustrating respective laminated body states according to different lamination pressure conditions (1 MPa, 10 MPa, and 30 MPa) when a laminated body of a ceramic green sheet obtained from a comparative example according to a related art is fabricated; and

FIG. 9 is a graph illustrating respective firing shrinkage rates of laminated bodies of ceramic green sheets obtained from an embodiment according to the present invention and a comparative example according to a related art.

### DETAILED DESCRIPTION OF THE PREFERRED EMBODIMENT

Exemplary embodiments of the present invention will now be described in detail with reference to the accompanying drawings.

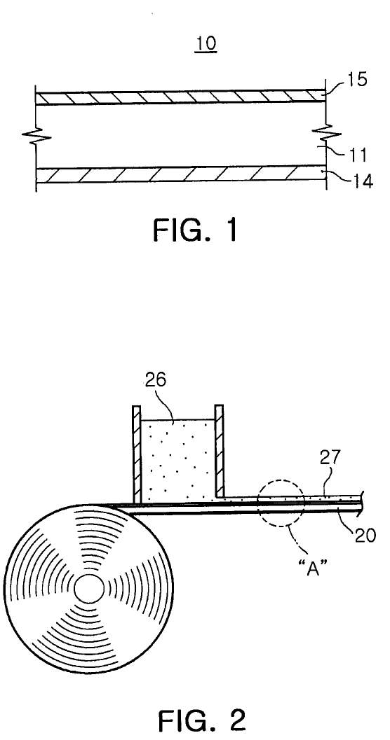

FIG. 1 is a cross-sectional view of a carrier film for forming a ceramic green sheet according to an embodiment of the present invention.

Referring to FIG. 1, a carrier film 10 for forming a ceramic green sheet includes a film-type base material 11, a delamination layer 14 disposed on a bottom surface of the film-type base material 11, and a binder layer 15 disposed on a top surface of the film-type base material 11.

A polyester (PET) film may be mainly used as the film-type base material 11. The delamination layer 14 may be fabricated by coating a resin having a releasing property such as a silicon resin onto the bottom surface of the film-type base material 11. The delamination layer is well separated when the carrier film is wound in a roll shape. In addition, the delamination layer 14 may include an antistatic agent such as a conductive material so that a static electricity is not generated.

The carrier film 10 according to this embodiment further includes the binder layer 15 disposed on the film-type base material 11. A binder solution mixing a binder resin with a solvent may be coated and then dried to obtain the binder layer 15.

The binder resin may be formed of at least one selected from the group consisting of vinyl-based resins such as polyvinyl alcohol, polyvinyl butyral, and polyvinyl chloride, cellulose-based resins such as methyl cellulose, ethyl cellulose, and hydroxyethyl cellulose, and acrylic-based resins such as polyacrylate esters and polymethyl methacrylate (PMMA). However, the present invention is not limited thereto. For example, aqueous binder resins or well-known various binder resins adaptable in a ceramic green sheet fabrication process may be used as the binder resin.

The solvent may be formed of a single solvent or a mixture mixed by two or more solvents selected from the group consisting of methyl ethyl ketone, ethylalcohol, isopropyl alcohol, toluene, diethyl ether, trichloro ethylene, and methanol. However, the present invention is not limited thereto. For example, all commonly used solvents that can dissolve the binder resin may be used as the solvent.

In case where an amount of the binder resin is insufficient, it is difficult to form the binder layer 15 after drying. Also, in case where an amount of the solvent is insufficient, it is difficult to from the binder layer because the binder resin is not sufficiently dissolved. Thus, in a composition ratio of a mixed solution for the binder layer 15, a mixing ratio of the binder resin to the solvent may range from about 5 wt %: 95 wt % to about 10 wt %: 90 wt %.

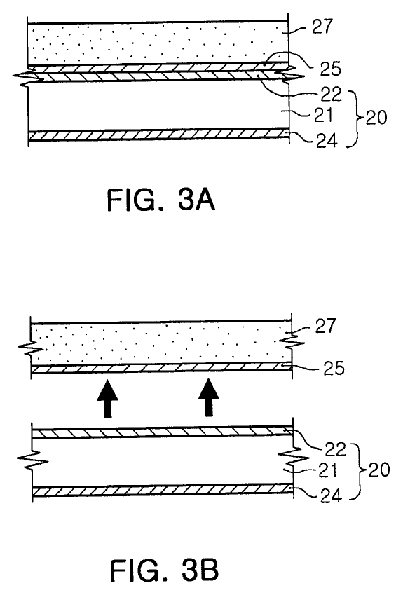

In the ceramic green sheet fabrication process, a solvent of a ceramic slurry coated onto the binder layer 15 may be dissolved in a portion of a surface of the binder layer 15 to integrate the ceramic green sheet into the binder layer 15. Thus, after the drying process of the ceramic green sheet, the ceramic green sheet may be separated in a state where the ceramic green sheet is attached to a bottom surface of the binder layer 15. A detailed process with respect to the above-described processes will be described below with reference to FIGS. 2, 3A and 3B.

FIG. 2 is a view illustrating a ceramic slurry coating process using a doctor blade process capable of being used in a ceramic green sheet fabrication process according to an example of the present invention. A carrier film for forming a ceramic green sheet illustrated in FIG. 2 serves as a carrier film according to the present invention, and a concrete configuration of the carrier film will be comprehended with reference to FIGS. 3A and 3B.

Referring to FIG. 2, a ceramic slurry 26 is supplied from a storage to a top surface of the carrier film 20 using a doctor blade process to coat the ceramic slurry 26 to a predetermined thickness. The coated slurry is dried to form a ceramic green sheet 27.

FIG. 3A is a partially enlarged view of a portion “A” of FIG. 2. Referring to FIG. 3A, the carrier film 20, similar to the configuration of FIG. 1, includes a first delamination layer 24 disposed on a bottom surface of a film-type base material 21 and a binder layer 25 disposed on a top surface of the film-type base material 21. In addition, the carrier film 20 may further include a second delamination layer 22 on the top surface of the film-type base material 21 before the binder layer 25 is disposed.

Thus, the ceramic green sheet 27 is disposed on the binder layer 25. As a result, the ceramic green sheet 27 may be stably supported by the binder layer 25. Also, binder resin contents within the ceramic slurry may be significantly reduced to largely increase a packing density of ceramic powder.

A mixture of the ceramic powder and the binder resin for the ceramic slurry may contain the ceramic powder ranging form about 90 wt % to about 99.5 wt % and the binder resin ranging from about 0.5 wt % to about 10 wt %, based on the total weight. Specifically, the mixture may contain the ceramic powder ranging form about 97 wt % to about 99.5 wt % and the binder resin ranging from about 0.5 wt % to about 3 wt %. The ceramic slurry may further include a small amount of additives such as a dispersant and a plasticizer, if necessary. A packing density of the ceramic green sheet may have a high packing ratio of 80% or more, specifically, 90% or more.

As described above, since the ceramic slurry has improved binder dispersibility and high ceramic powder contents due to the low binder contents, a powder packing density of the ceramic green sheet to be fabricated significantly increases. In addition, in spite of the low binder resin contents of the ceramic slurry, since the ceramic slurry is maintained by the binder layer 25 previously prepared on the carrier film, the ceramic green sheet to be fabricated may be sufficiently thin even though the ceramic slurry has the low binder contents.

Referring to FIG. 3A, in the ceramic green sheet 27 obtained from the ceramic slurry, since a solvent of the ceramic slurry is penetrated and dissolved into a surface of the binder layer 25 in a coating process in a state of a slurry state, the ceramic green sheet 27 and the binder layer 25 may be integrated with each other.

Referring to FIG. 3B, when the ceramic green sheet 27 is separated from the carrier film 20, the ceramic green sheet 27 may be separated from an interface between the binder layer 25 and the second delamination layer 22. Thus, the ceramic green sheet 27 may be integrated with the binder layer 25. Also, since the binder layer 25 is disposed on the bottom surface of the ceramic green sheet 27, it can prevent the ceramic green sheet 27 from being damaged when handling in a subsequent process even if coupling between powder is low due to the low binder contents, or the ceramic green sheet 27 becomes very thin up to several μm thickness.

A plurality of ceramic green sheets is laminated when a multilayer ceramic component is fabricated. In this case, the binder layer 25 disposed on the bottom surface of the ceramic green sheet 27 may increase an interlayer coupling. Also, since the ceramic slurry has the low binder resin contents, the number of pores generated after firing in the multilayer ceramic component fabrication process may be significantly reduced. In addition, since it is possible to further accurately predict a shrinkage rate, the multilayer ceramic component having improved reliability can be fabricated.

Hereinafter, an operation and an effect according to the present invention will be described in detail through specific a specific embodiment of the present invention.

### Embodiment

A ceramic slurry having a composition ratio shown in Table 1 was fabricated in this embodiment. In the ceramic slurry used in this embodiment, a mixing ratio of ceramic powder to a binder resin is about 98:2. Specifically, the ceramic slurry adopted for the this embodiment is fabricated using a ceramic slurry prepared by mixing a mixture containing ceramic powder of Al₂O₃ (41.35) and glass (55.33) and a binder resin (1.95) with a solvent. Toluene and ethanol was used as the solvent. A mixing ratio of the toluene to the ethanol was about 10.41 wt %: about 8.14 wt %.

TABLE 1

| | | Composition (wt %) of ceramic slurry |
|---|---|---|
| Component | | (embodiment) |
| Ceramic powder | Al₂O₃ | 41.35 |
| | Glass | 55.33 |

| | |
|---|---|
| Binder resin | 1.95 |
| Dispersant | 0.97 |

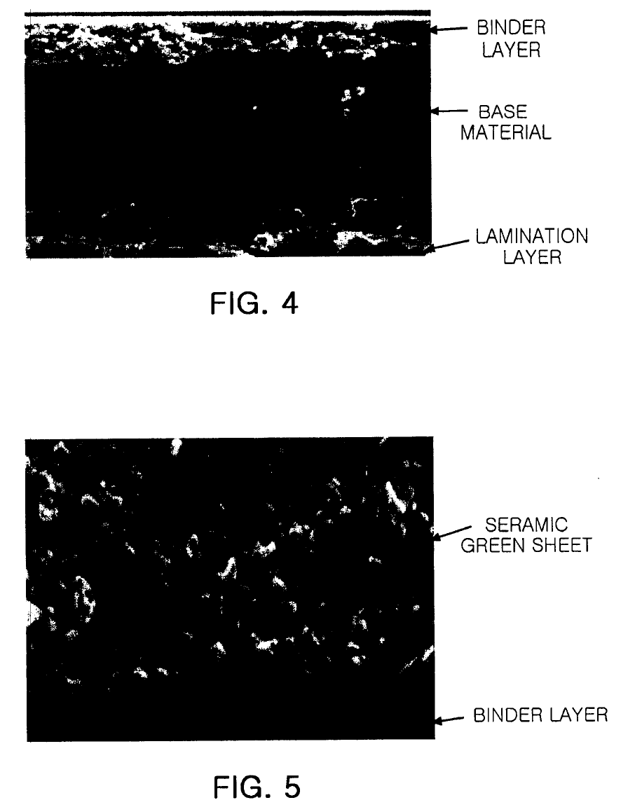

In this embodiment, a carrier film including a polyethylene film base material and a delamination layer fabricated by coating a silicon-based resin onto a bottom surface of the polyethylene film base material was used. Specifically, according to the present invention, a binder layer was disposed on the delamination layer. A polyvinyl alcohol binder resin is used as the binder layer. FIG. 4 is a photograph showing a cross-section of the carrier film used in this embodiment.

The ceramic slurry was coated onto the carrier film including the binder layer according to this embodiment using a doctor blade process and then dried to fabricate a ceramic green sheet.

FIG. 5 is a photograph showing a cross-section of the ceramic green sheet fabricated according to this embodiment. Referring to FIG. 5, it can be seen that a surface of the binder layer is dissolved by the solvent of the ceramic slurry on an interface between the ceramic green sheet and the binder layer to couple the ceramic green sheet to the binder layer. As a result, the binder layer may be disposed on a bottom surface of the ceramic green sheet when the ceramic green sheet is separated from the carrier film.

### Comparative Example

A ceramic slurry was fabricated with a composition ratio shown in Table 2 in this comparative example. In the ceramic slurry, a mixing ratio of ceramic powder to a binder resin is about 87:13 similar to a related art condition.

In this comparative example, a mixed solvent mixing toluene with ethanol is used for the ceramic slurry, similar to the preceding embodiment. A mixing ratio of the toluene to the ethanol was about 19.41 wt %: about 13.29 wt %.

TABLE 2

| | | Composition (wt %) of ceramic slurry |
|---|---|---|
| Component | | (comparative example) |
| Ceramic powder | Al₂O₃ | 37.23 |
| | Glass | 49.35 |

| | |
|---|---|
| Binder resin | 12.98 |
| Dispersant | 0.44 |

In this comparative example, similar to the preceding embodiment, a carrier film including a polyethylene film base material and a delamination layer fabricated by coating a silicon-based resin onto a bottom surface of the polyethylene film base material was used. However, a binder layer was not disposed additionally.

The ceramic slurry was coated onto the carrier film including the binder layer according to this comparative example using a doctor blade process and then dried to fabricate a ceramic green sheet.

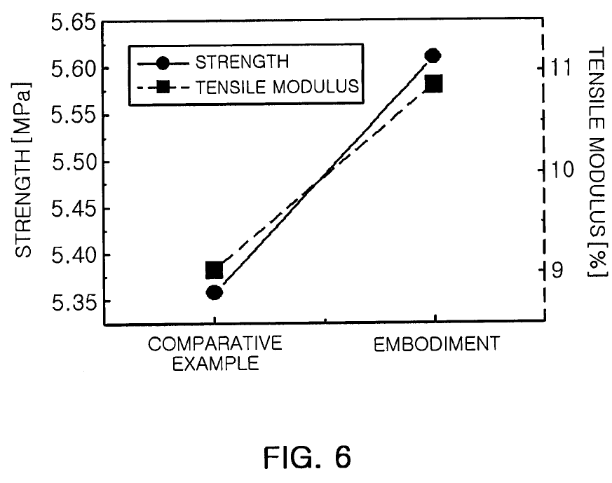

A tensile test with respect to the ceramic green sheets fabricated according to the embodiment and the comparative example was performed. FIG. 6 is a graph illustrating tensile test results of the ceramic green sheets.

Referring to FIG. 6, it can be seen that the green sheet according to this embodiment has an improved tensile strength and tensile modulus when compared to those of the ceramic slurry fabricated according to the comparative example even though the green sheet according to this embodiment is fabricated with low binder contents.

Therefore, since the ceramic green sheet using the carrier film according this embodiment has relatively strong tensile strength due to the binder layer disposed on the bottom surface thereof, the ceramic green sheet has further superior strength characteristics in comparison with the comparative example even though the binder contents within the ceramic green sheet are about one-tenth of those of the comparative example.

Respective ten ceramic green sheets fabricated according to the embodiment and the comparative example were laminated and compressed to fabricate respective laminated bodies. The laminated bodies were plasticized and fired to fabricate respective sintered bodies.

In this process, a density of the ceramic green sheet and a resultant structure according to the embodiment and a density of the ceramic green sheet and a resultant structure according to the comparative example were measured at each of steps of lamination, plasticization, and firing, and the measured results are shown in Table 3. It can be seen that the density is very high at each of the steps.

TABLE 3

| | | Comparative |
|---|---|---|
| | Embodiment | example |
| Green sheet density (g/cm³) | 2.19 | 1.88 |
| Density after lamination | 2.29 | 2.05 |
| process (g/cm³) | | |
| Density after plasticization | 2.08 | 1.80 |
| process (g/cm³) | | |
| Density after firing | 2.97 | 2.89 |
| process (g/cm³) | | |

As described above, since the binder layer disposed on the bottom surface of the ceramic green sheet supports the green sheet and improves a lamination property, the binder contents within the green sheet are reduced, and thus, a ceramic fraction increases to increase the density of the green sheet. As a result, the number of pores decreases to increase a density of a fired body. Therefore, the ceramic green sheet having a very high powder packing density can be obtained. Also, the ceramic green sheet can have a packing ratio of 80% or more.

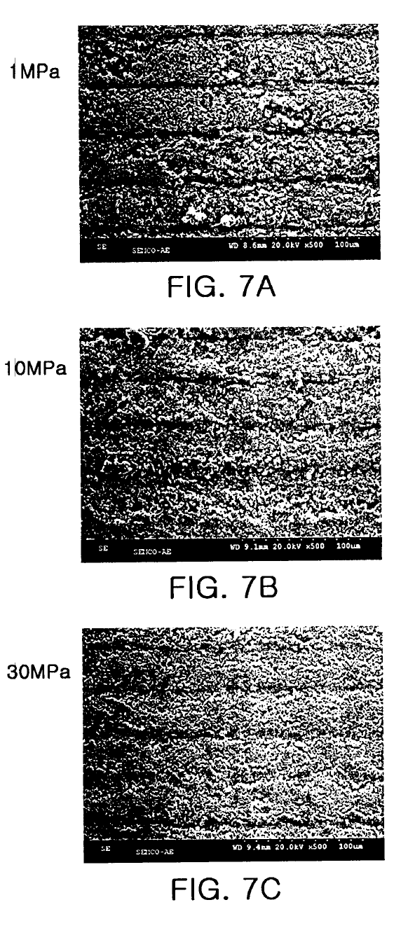

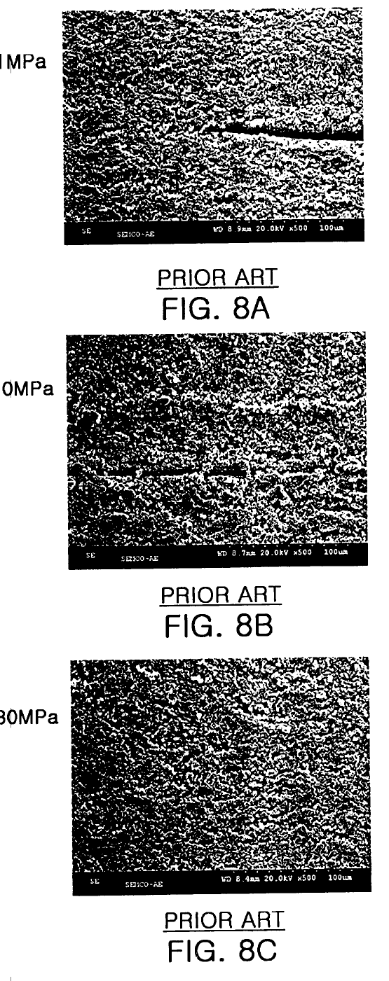

FIGS. 7 and 8 are cross-sectional photographs illustrating respective laminated bodies obtained by laminating a green sheet according to an embodiment and a comparative example. Here, respective different lamination pressures (1 MPa, 10 MPa, and 30 MPa) are applied to illustrate laminated states at the respective pressures.

A laminated body of the comparative example does not have a sufficient interlayer adhesive force at a lamination pressure of 10 MPa or less to cause a lamination phenomenon. It can be seen that an interlayer coupling without causing a fault is obtained at a high pressure of 30 MPa. On the other hand, it can be seen that a uniform laminated body without causing a fault is fabricated at only a low pressure of 1 MPa in a laminated body using a ceramic green sheet of this embodiment. A binder layer disposed on a lower portion of a ceramic tape serves as an adhesive to significantly improve a lamination property. Specifically, it can be seen that the interlayer coupling force can be significantly improved using only one-tenth of existing binder contents.

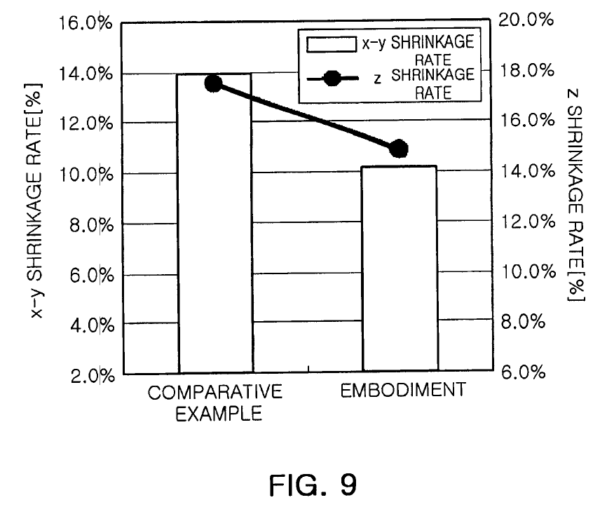

In the above-described firing process, respective firing shrinkage rates with respect to the sintered bodies according to the embodiment and the comparative example were measured. FIG. 9 is a graph illustrating respective firing shrinkage rates of laminated bodies of ceramic green sheets obtained from an embodiment according to the present invention and a comparative example according to a related art.

Referring to FIG. 9, the ceramic green sheet obtained according to this embodiment has a high powder fraction when compared to that of the comparative example. Thus, the density of the laminated body is very high, and the number of pores generated by the binder decreases. As a result, the same firing characteristics can be achieved even though the laminated body has the low shrinkage rate. Also, since a pore generation rate due to the binder is low, the shrinkage rate can be relatively accurately predicted to advantageously fabricate sintered products having a further accurate dimension.

As described above, according to the present invention, since the macromolecular binder contents within the ceramic slurry is minimized, dispersibility can be significantly improved, and the ceramic powder packing density can significantly increase. Since the number of pores is less after the firing process, the shrinkage rate is low, and the firing density is high. Also, since the binder layer is disposed on the bottom surface of the ceramic green sheet through the carrier film, the thin film green sheet that can be easily treated can be fabricated by adjusting a thickness of the binder layer.

Furthermore, since the binder layer is uniformly distributed, the high interlayer coupling force can be obtained so that the binder layer is insensitive during the laminating process.

While the present invention has been shown and described in connection with the exemplary embodiments, it will be apparent to those skilled in the art that modifications and variations can be made without departing from the spirit and scope of the invention as defined by the appended claims.

What is claimed is:

1. A carrier film for forming a ceramic green sheet, comprising:
a film-type base material for fabricating the ceramic green sheet;
a binder layer disposed on the film-type base material, the binder layer being formed of a binder resin; and
a delamination layer disposed on a bottom surface of the carrier film, the delamination layer being formed of a resin having a releasing property.

2. The carrier film of claim 1, wherein the binder resin is formed of at least one selected from the group consisting of vinyl-based resins, cellulose-based resins, and acrylic-based resins.

3. The carrier film of claim 1, further comprising an additional delamination layer disposed between the binder layer and the film-type base material and formed of the resin having the releasing property.

4. A method of fabricating a ceramic green sheet, the method comprising:
preparing a carrier film for forming the ceramic green sheet including a film-type base material for fabricating the ceramic green sheet, a binder layer disposed on the film-type base material, the binder layer being formed of a binder resin, and a delamination layer disposed on a bottom surface of the carrier film, the delamination layer being formed of a resin having a releasing property;
coating a ceramic slurry onto the carrier film; and
drying the coated ceramic slurry to form the ceramic green sheet.

5. The method of claim 4, further comprising separating the ceramic green sheet from the carrier film so that the binder layer is maintained on a bottom surface of the ceramic green sheet.

6. The method of claim 4, wherein the ceramic slurry is prepared by mixing a solvent with a mixture of at least ceramic powder and binder, and the mixture contains the ceramic powder ranging from about 90 wt % to about 99.5 wt % and the binder ranging from about 0.5 wt % to about 10 wt %, based on a total weight.

7. The method of claim 4, wherein the ceramic green sheet has a ceramic powder packing density of about 90% or more.

8. The method of claim 4, wherein the binder resin is formed of at least one selected from the group consisting of vinyl-based resins, cellulose-based resins, and acrylic-based resins.

9. The method of claim 4, further comprising an additional delamination layer disposed between the binder layer and the film-type base material and formed of the resin having the releasing property.
